(19) United States
(12) Patent Application Publication
(10) Pub. No.: US 2007/0115826 A1
(43) Pub. Date: May 24, 2007

(54) SYSTEMS AND METHODS FOR INCREASING CAPACITY IN COLLISION-BASED DATA NETWORKS

(75) Inventor: Peter E. Chow, Orlando, FL (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Optimal Licensing Corporation, Freeport (BS)

(21) Appl. No.: 11/538,321

(22) Filed: Oct. 3, 2006

Related U.S. Application Data
(60) Provisional application No. 60/726,459, filed on Oct. 14, 2005.

(51) Int. Cl. H04J 1/16

(52) U.S. Cl. 370/235; 370/412

(57) ABSTRACT

A multiple-access contention-free environment is disclosed for a local area network without using centralized control and without using information contained in the data. Data collisions are eliminated by buffering data from connected devices when the bus (or other common transportation media) is not available for immediate use. In one embodiment, the buffering is controlled by hubs that can accept information or hold it up for a period of time until the buffer clears. Buffer fullness can be used, if desired, as a measure as to which buffer to draw from first. When buffers are full, signals are sent to the stations to reduce their access to the network on a temporary basis.

The present application claims priority to co-pending U.S. Provisional Patent Application Ser. No. 60/726,459, entitled “FRAME MULTIPLEXER FOR LOCAL AREA NETWORK,” filed Oct. 14, 2005, the disclosure of which is hereby incorporated herein by reference.

### TECHNICAL FIELD

This invention relates to multiple access data networks and more particularly to systems and methods for avoiding collisions while increasing throughput.

### BACKGROUND OF THE INVENTION

Ethernet is a common multiple access control (MAC) protocol used to handle data flow in local area networks. Because data from multiple points flows over a common transmission media, collisions in the form of multiple simultaneous contentions for the same medium among data from different points can occur. To handle such contentions, networks are sized on a probability basis to minimize contentions and tokens are used to mediate among multiple simultaneous accesses. Sizing of the network to reduce contention issues results in lowered capacity as measured by throughput.

One known possibility to reduce contentions is to join every station together via switches, routers or bridges. Such a solution is costly. Another costly solution is to increase the number of switches in the local network, thereby isolating the stations while reducing contentions. This approach may not allow the data to flow faster, but it does have the advantage of collision reduction and thus reduces the number of retries. One advantage of using more switches is that some local traffic, such as traffic to a printer, need not travel the entire network but rather can be switched to the printer branch. The cost of each additional switch is high, roughly six or seven times the cost of a hub, and thus not an effective solution.

One example of a multiple access system implemented for satellite communication is the Aloha system between Hawaii and the U.S. mainland. The multiple access protocol is based on the partitioned interval in time. All the stations have equal opportunity of accessing the medium at the beginning of each interval only. If two or more stations attempt to transmit at the same interval a collision would occur and the transmissions would be lost. The “lost” transmissions would be retransmitted a short time later. The Aloha protocol has a throughput expression with the maximum of 36.8%. Thus, the collision rate of 63.2% means that almost ⅔ of all transmissions must be repeated. Since 63% of the retransmission also collide, the actual throughput is very low.

One conclusion that can be drawn from this type of system is that the allowance of collisions, or medium contentions, has a large negative effect on throughput. Another conclusion is that traffic control is important and, in the case of the Aloha system, a level around 10% would be ideal.

Ethernet uses an enhanced multiple access protocol called Carrier Sense Multiple Access with Collision Detection (CSMA/CD). The scheme provides for each station wishing to transmit data to sample the signal level on the shared transmission medium. If the transmission medium is idle for a fixed duration, then the station can transmit data at that time. If a collision occurs between multiple stations (all of whom begin transmission at roughly the same time), all transmitting stations are required to stop transmitting. The data that otherwise would have been transmitted (but for the collision) is retransmitted after a random delay. The delay being random is thus different for every station.

It is difficult to make throughput calculations for an Ethernet protocol since throughput model for the Ethernet protocol has too many variables. In some situations, there are conditions for a high throughput and other conditions lead to very poor throughput. Under high traffic conditions there has been no demonstration of lowered collision rate. Finally, while a station might have an “advertised” throughput, the actual throughput could be much lower depending upon factors outside the control of the station and thus not calculable or manageable by the station. Accordingly, traffic management is difficult.

### BRIEF SUMMARY OF THE INVENTION

The concepts discussed herein are directed to providing a multiple-access contention-free environment for a local area network without using centralized control and without using information contained in the data. Systems and methods are disclosed for reducing potential data collisions by buffering data from connected devices when the bus (or other common transportation media) is not available for immediate use. In one embodiment, the buffering is controlled by hubs that can accept information or hold it up for a period of time until the buffer clears. By using the hub approach, data packets can be buffered and then when the bus is available, multiplexed onto the bus. The buffering can occur several times if necessary. In some embodiments, buffer fullness is used as a measure as to which buffer to draw from first. When buffers are full, signals are sent to the stations to reduce their access to the network on a temporary basis. In this manner, collisions are avoided without requiring the network to look into a packet to obtain header information. The concepts discussed herein can be used in either a bus or tree configuration.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a frame multiplexer used in a bus topology in accordance with one aspect of the invention;

FIG. 2A shows the frame multiplexer used in a tree network topology;

FIG. 2B shows a prior art tree network structure;

FIGS. 3A and 3B illustrate uni-directional frame multiplexers; and

FIG. 4 illustrates a frame multiplexer arranged with full-duplex operation;

### DETAILED DESCRIPTION OF THE INVENTION

Prior to beginning a detailed discussion of some illustrative embodiments of the invention, it might be helpful to review the basic architecture of Ethernet protocol implementations. In terms of Ethernet local area network (LAN) configurations, there are bus and tree configurations. The bus configuration allows direct access by every station. Ethernet CSMA/CD was designed for this purpose, i.e., to a share medium for all stations.

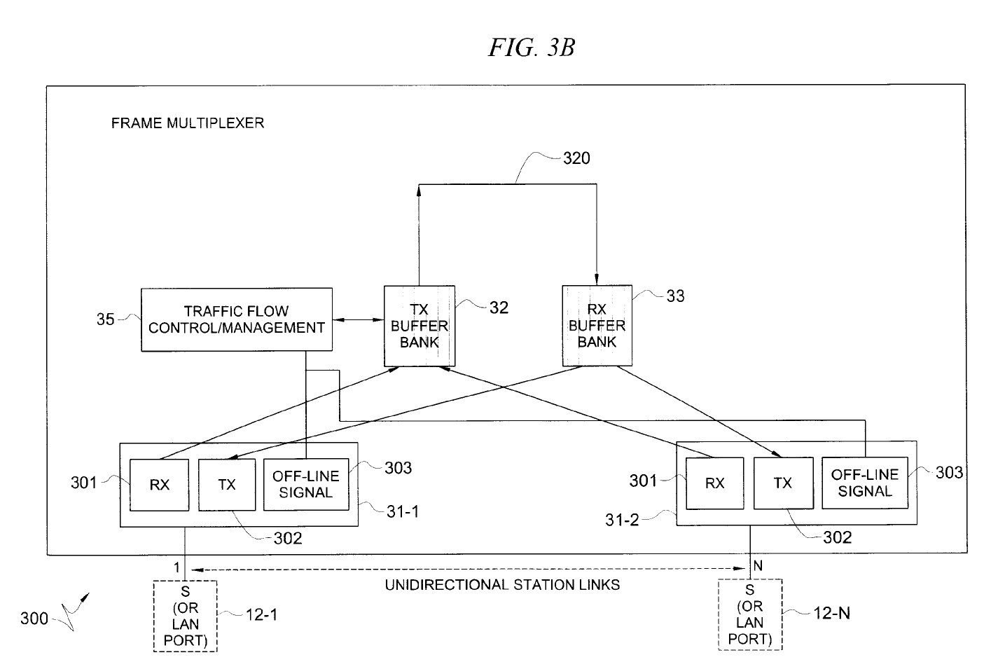

The tree structure is a hierarchical structure where stations are located at the bottom of the hierarchical structure and the gateway to the external network is located at the top of the hierarchical structure. The number of layers in between the top to bottom layers is based on the number of stations and traffic volume. In the tree structure, each station has its own medium (cable, air link) to the next level in the hierarchy. Ideally, the second least level should be a router which would eliminate the shared medium issues. For economical reasons, a HUB is often used to convert the individual mediums into a shared medium by having a common bus for all inputs. The HUB has multiple ports; each port having (as shown in FIG. 3A) a pair of TX (transmit) and RX (receive) ports which are connected to stations and next level equipment. To make the HUB work with CSMA/CD, all TX and RX ports are connected to the bus. RX ports place data on the bus and simultaneously all TX ports take the same data out of the bus as equivalent to broadcasting data to destinations that connected to ports. Note that in this context, the HUB is a physical layer device which does not read the contents in a packet. The transmission is over whatever transport medium the TX port is connected. Since the RX port feeds place data onto the bus media, every RX port feeds a shared medium where collisions can happen. If the data is not collided, then the TX ports must broadcast to the origin that the data arrived as defined by CSMA/CD protocol. If collisions are determined, then signals are sent to buffer the data for a period of time.

The network configuration has the choice of duplex (two wires, one bi-directional medium) or full duplex (four wires, two uni-directional mediums) connectivity to stations. The embodiments discussed herein describe four wire operation, but the same principle is applicable to a two-wire medium. As will be seen, some of the advantages of the concepts discussed herein are the elimination of collisions by using buffers and the elimination of the traffic overload by sending a stopping transmission signal to sources which are causing the overload. It is anticipated that these concepts will increase throughput traffic at least by a factor of six because:

a. both media can transmit and receive at the same time versus uni-direction transmission by the CSMA/CD. Hence the throughput capacity is double;

b. Collisions are avoided thereby eliminating the need for retransmission. Hence, the throughput capacity increases by 2.5 times;

c. There is no medium idle time before transmission required. Hence, the throughput capacity would increase by 1.2 times; and

d. The quality of service is improved because retransmission is reduced thereby improving latency.

For ease of discussion herein, the term “Frame Multiplex” will refer to a HUB modified as per the discussion herein.

Advantage is taken of the property of the existing CSMA/CD protocol to stop transmission onto the media when the equipment receives a media busy signal. With backward compliable to Ethernet CSMA/CD, then the traffic from the station can stop by sending a carrier signal to the station. With enhancement to the Ethernet standard, a unique start and stop signal can be used to turn off the traffic flow from the station to the Super HUB. However, even when the station is not sending data to the network, data can still flow to the station. For example, if the station has transmitted too much signal to the super HUB, the super HUB would transmit a stop signal to the station. Upon receiving the stop signal, the station would continue to transmit its data to complete the packet and stop any new packet transmission until a resume signal is received. As discussed, at all times data can be sent to the station without interruption. This scheme provides bi-direction traffic which is twice as efficient as the standard CSMA/CD protocol.

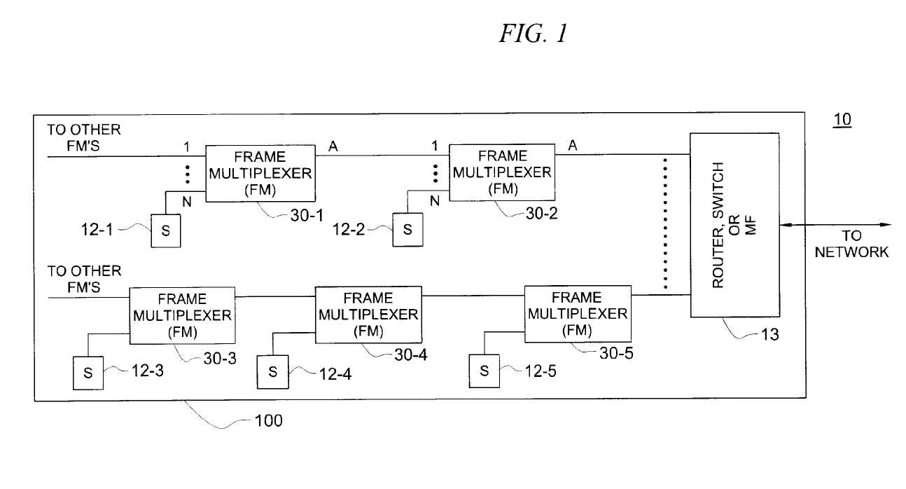

FIG. 1 shows one embodiment 10 of a network of frame multiplexers, such as network 100, in accordance with one aspect of the invention. Network 100 then multiplexes a number of stations, such as stations 12-1 to 12-5, onto Ethernet Local Area Network (LAN). As will be discussed, network 100 operates to increase throughput onto the LAN while reducing collisions.

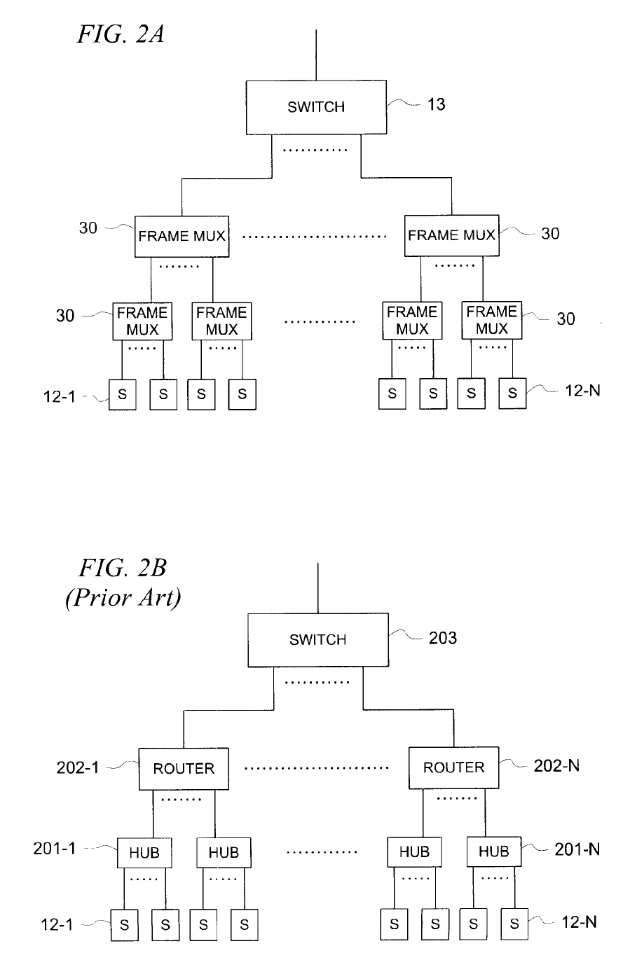

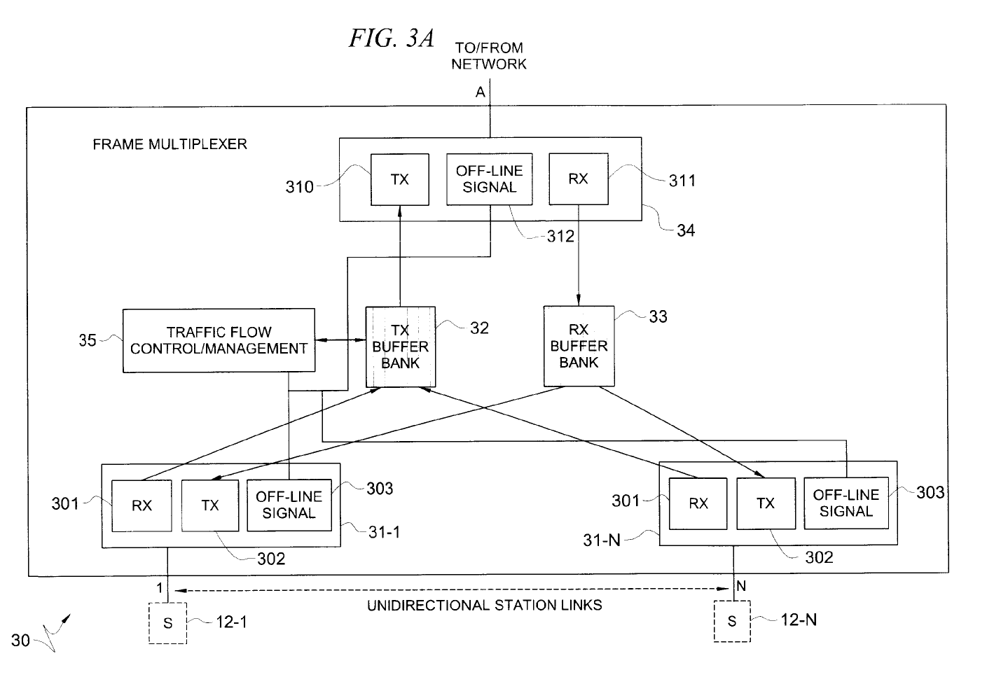

FIG. 2A shows the frame multiplexer of the present invention used in a tree network topology replacing the HUB in a prior art tree structure as shown in FIG. 2B where hubs 201-1 to 201-N connect the stations to routers 202-1 to 202-N and to the network via switch 203.

FIGS. 3A and 3B illustrate uni-directional frame multiplexers 30 and 300, respectively, in accordance with an embodiment of the invention,

With respect to FIG. 3A, data coming from the connected station 12-1 (or any other stations 12-N) passes through RX input 301 and put into TX buffer 32 awaiting transmission onto output A via TX output 310. Data into and out of the buffer is controlled by traffic flow control management 35 which could be hard wired or processor controlled or a combination thereof. Likewise, data incoming from the network via input port A is directed to TX control of ports 1 to N via RX 311 of input control 34 via buffer 33. TX and RX control can be passive ports or could be active to provide amplification, or other control, to “dress” the signals to/from the station (or other FM).

Let us assume the system is operated in normal condition. The normal condition means the data buffer is not overflowing. Under this condition, one or more stations are sending packets to FM. FM will store these received packets in TX buffer bank 32 and send buffered data as fast as possible to port A. The reverse path is the same, e.g., the packet received at port A will be stored in RX buffer bank 33 and will send the buffered data in a broadcasting mode to all ports from 1-N. This operation is contention free, i.e., no collision. Before discussing the situation of heavy traffic condition that could overflow the buffer, the three choices of buffer configurations will be discussed, namely totally sharing the buffer by all ports 1-N, 1-N individual port buffers or the combination of shared and individual port buffer.

The shared buffer would use all memories in the buffer to hold data from all ports. When the buffer is near to overflowing, the traffic flow control signal would apply to all ports. The advantage of this partitioning is more storage capacity for uneven traffic rate from ports 1-N, but less control on traffic rate guarantees per port. The individual port buffer partitioning has less storage for heavy traffic ports, but individual port traffic can be managed independent of other ports such that when any buffer is near to overflow, the data will stop, even if other buffers have capacity. The combination of shared and individual buffers is a reasonable combination of storage capacity and individual control of traffic flows.

In a “combination” buffer system, the data from any port will go to the shared buffer until it is full. Any new data would be stored in the individual port buffer which will transfer that data to the shared buffer as soon as space is available. When an individual buffer is near to capacity, new incoming data will be stopped. There are at least two ways to stop the incoming traffic to the port from the connected device (12-1 to 12-N). One way is to transmit a signal from the port to the connected device. This scheme is compatible CSMA/CD protocol. The signal could be the traffic received from port A in buffer 33. If buffer 33 has no real data, then some idle signal can be sent. In other words, buffer 33 would store real data from port A or an idle signal. Another scheme is to send stop and start signals to control the traffic flows from the connected device. The advantage is to make the two uni-direction transmissions into four wires that are independent to each other. This traffic flow control could be applied to port A as well (if the buffer has an idle signal, then the system does not need the off-line signal in FIG. 3A).

FIG. 3B shows another frame multiplexer configuration that is identical to FIG. 3A, except port A was replaced by a loop back. In doing so, it makes all ports from 1 to N identical. One of the ports could be assigned to and from the network such as port A in FIG. 3A. The remaining ports are connected to stations. The major difference is that an input to the FM would be loop backed and broadcast to all ports. Thus, all stations would receive all intra-traffic without going through the network. This feature will reduce network traffic if there is a lot of intra-network traffic.

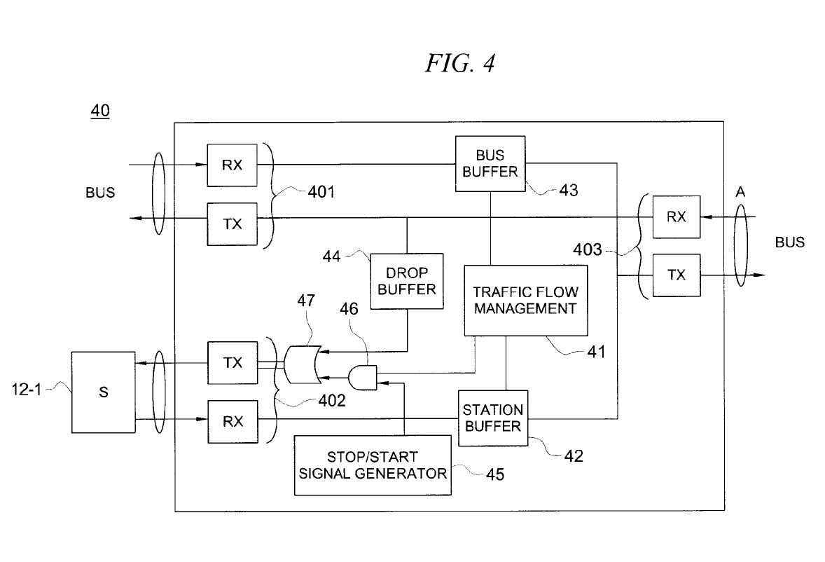

FIG. 4 illustrates a two port frame multiplexer 40 arranged to operate in a bus topology as shown in FIG. 1. The purpose is to allow a single station to couple to the bus without contention. The difference of FIG. 4 from FIG. 3A is three ports. FM and traffic control applied to the local station only, port 1. Since there will be multiple stations connected to port 401, traffic control of individual stations on the bus is not possible or this reason, the traffic priority at port 403 is always for the traffic at port 401, the traffic control is applied to port 402 by management 41 and buffer 45. The buffers, 44 and 42 to and from the single station, 12-1 are managed independently.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A network element for use in a multiple access network in which a plurality of devices can communicate over a common medium, said network element comprising:
means for receiving data from at least one of said devices, said data to be transported via said common medium to a destination one of said devices; and
means associated with said receiving means operative in response to a medium-in-use signal for buffering said received data until said medium is available for transporting said buffered data.

2. The network element of claim 1 wherein said destination device is determined by address information contained in received ones of said data.

3. The network element of claim 2 wherein said buffering occurs without reference to any information contained in said data.

4. The network element of claim 3 wherein said medium is selected from the list of: fiber cable, coaxial cable, twisted pair cable.

5. The network element of claim 1 further comprising:
means for communicating to a device sending data to said receiving means to temporarily refrain from sending more data.

6. A method of delivering data from one point to another in a multiple access local area network in which a plurality of devices can communicate over a common medium, said method comprising:
receiving data at a buffering point sent from at least one of said devices, said data to be transported from said buffering point via said common medium to a destination one of said devices: and
storing at said buffering point said received data during periods when said medium is unavailable for transporting said buffered data.

7. The method of claim 6 wherein said unavailability of said medium is communicated to said buffering point from time to time.

8. The method of claim 6 wherein said destination device is determined by address information contained in received ones of said data.

9. The method of claim 8 wherein said buffering occurs without reference to any information contained in said data.

10. The method of claim 6 further comprising:
sending a signal to said data sending devices to temporarily stop sending data to said buffering point.

11. A local area network comprising:
a medium for transporting data from point to point;
elements connectable to said medium and also connectable to devices from which data is sent and received;
buffers contained within at least some of said elements, said buffers operable for storing for periods of time data from a connected device; and
at least one control for communicating the unavailability of said common medium to said elements, said communicated unavailability causing said data to be stored at said element for a period of time consistent with said communicated unavailability.

12. The network of claim 11 wherein said control further comprises:
means for releasing data stored in said buffers such that said released data can be delivered without contention on said medium to a specific destination in accordance with address information contained in said data.

13. The network of claim 12 wherein said releasing means comprises:
means operable when a plurality of buffers have data stored therein for determining the order of releasing data from said buffers so as to avoid contentions on said medium.

14. The network of claim 13 wherein said determining means is enabled based upon one or more of the parameters selected from the list of: relative fullness of said buffers; pre-designated priority as between said buffers; sequentially in round-robin fashion; order that said buffers received data for storing.

15. The network of claim 11 further comprising;
means for instructing said connected device to stop sending data to said buffers.

16. A method of delivering data from one device to another in a multiple access network having at least one common medium, said method comprising:
buffering data from selected ones of said devices for periods of time when said medium is transporting data from another device; and
placing buffered data on said medium for transportation to an address contained within said data when said medium is available for such transportation.

17. The method of claim 16 wherein said placing comprises:
determining the order of releasing data from said buffers so as to avoid contentions on said medium as between buffers having data stored therein.

18. The method of claim 17 wherein said determining is enabled based upon one or more of the parameters selected from the list of: relative fullness of said buffers; pre-designated priority as between said buffers; sequentially in round-robin fashion; order that said buffers received data for storing.

19. The method of claim 17 wherein said buffering occurs without regard to any information contained within said data.

20. The method of claim 19 further comprising:
instructing said selected device to temporarily stop sending data to said buffer.
